(19) United States
(12) Patent Application Publication
(10) Pub. No.: US 2021/0161096 A1
(43) Pub. Date: Jun. 3, 2021

(54) LITTER COLLECTION DEVICE FOR EFFICIENT ANIMAL WASTE REMOVAL AND METHOD THEREOF

(71) Applicant: PETATO TECHNOLOGY LIMITED, Hong Kong (CN)

(72) Inventors: Chao FAN, Hong Kong (CN); Xuran CHENG, Hong Kong (CN)

(73) Assignee: PETATO TECHNOLOGY LIMITED, Hong Kong (CN)

(21) Appl. No.: 17/171,982

(22) Filed: Feb. 9, 2021

Related U.S. Application Data
(63) Continuation of application No. PCT/CN2019/102034, filed on Aug. 22, 2019.
Application No. PCT/CN2019/102034 is a continuation of application No. 16/112,918, filed on Aug. 27, 2018.

(51) Int. Cl. A01K 1/01

(52) U.S. Cl. CPC A01K 1/011; A01K 1/0114

(57) ABSTRACT

Embodiments of the disclosure provide a device for handling an animal waste deposited by an animal. The device includes a device base comprising a receptacle and a chamber located on the device base that is rotatable about an axis of rotation. The chamber includes a chamber opening being operable as an ingress for the animal to deposit the animal waste when the chamber is in a first position and being operable as a waste opening for dumping the animal waste to the receptacle when the chamber is in a second position, and a partition located within the chamber. The partition includes one or more screen sections, each having one or more screen openings thereon, and at least one non-opening section being connected to an interior wall of the chamber. The non-opening section and the interior wall of the chamber form a trough for temporarily storing a litter material.

### CROSS-REFERENCE TO RELATED APPLICATIONS

This application is a bypass continuation of PCT application No. PCT/CN2019/102034 filed Aug. 22, 2019, which claims the benefit of priority to U.S. patent application Ser. No. 16/112,918 filed on Aug. 27, 2018, both of which are incorporated herein by reference in their entireties.

### TECHNICAL FIELD

The present disclosure relates to a litter collection device for sifting animal waste, and more particularly, to an improved self-cleaning device that automatically separates animal waste from litter material efficiently.

### BACKGROUND

A potty device filled with litter material, such as sand, dried clay, or cat litter, can be used to let pet animals to excrete waste. After the excretion, the waste sticks to or soils the litter material to form soiled animal waste so that the potty device can be easily cleaned up. However, the used litter material must be cleaned before the animal waste piled up to a certain extent. In an effort to relieve pet owners from performing a highly unpleasant recurring task of cleaning the animal waste, such as animal excrement or coagulated litter, from the unsoiled litter material, various types of self-cleaning potty device are designed to separate animal waste automatically from the litter material for the ease of disposal. One method is to use a motor to drive a separation device, such as rake, porous scoop, sifting screen, filtration grid, or sifting drawer, through the litter material and thus separate the animal waste from the litter material. The separated animal waste is then pushed to a waste collector, such as storage bag or waste compartment placed outside the chamber, for cleaning.

However, the conventional self-cleaning potty devices are usually structured with a chamber partially filled with litter material comprising at least two openings. The first opening provides an entrance and an exit for the pet animal, while the second opening is provided for accessing a waste collector outside the chamber whereby the waste material may be dropped into. Such conventional devices with two openings have great disadvantages. When the devices are sifting the waste material and dumping the waste material through the second opening, for example, by rotating the chamber to a predetermined position, the first opening is still accessible by pet animals. This poses a threat to the pet animal's safety as they may get injured by the moving parts when the moving parts drive through the litter material. Furthermore, the chamber with two openings cannot provide sufficient space for a large opening as entrance or exit. For example, if the pet animal is very tall, it will be very difficult for the pet animal to squeeze itself into the chamber.

Other conventional self-cleaning potty devices use a separation device that is movably mounted in the interior volume of the chamber. By a predefined movement of the separation device inside the chamber, the waste material is separated from the litter by the separation device. The drawback of these devices is that they require a complicated design to ensure the effectiveness of the separation device at every corner of the chamber. Also, the movable parts of the separation device inside the chamber can trap small material. Clumps of waste material or litter material can be wedged and built-up within the separation device. As a result, the separation device or other moving parts inside the chamber may be clogged or jammed and the waste can easily be accumulated therein, causing odors and unpleasant smells. More pet owner manual interactions are required to remove the waste material trapped inside the separation device, which is not a pleasant experience for the pet owner.

Embodiments of the present disclosure address the above problems by providing a litter collection device for separating animal waste using an improved sifting method for filtering the animal waste without posing any danger to the pet animals.

### SUMMARY

Embodiments of the disclosure provide a device for handling an animal waste deposited by an animal. The device includes a device base including a receptacle and a chamber located on the device base that is rotatable about an axis of rotation. The chamber includes a chamber opening being operable as an ingress for the animal to deposit the animal waste when the chamber is in a first position and being operable as a waste opening for dumping the animal waste to the receptacle when the chamber is in a second position, and a partition located within the chamber. The partition includes one or more screen sections, each having one or more screen openings thereon, and at least one non-opening section being connected to an interior wall of the chamber. The non-opening section and the interior wall of the chamber form a trough for temporarily storing a litter material. When the chamber is rotated from the first position to the second position, the litter material passes through at least one of the screen sections and enters the trough, and the animal waste is kept out of the trough by the partition and removed to the receptacle through the chamber opening. When the chamber is rotated from the second position to a third position, the litter material exits the trough.

Embodiments of the disclosure also provide a method for handling an animal waste deposited in a device. The method includes providing a litter collection device having a receptacle and a chamber with a chamber opening. The chamber opening serves as an ingress for the animal to deposit the animal waste on a litter material when the chamber is in a first position. The method also includes rotating the chamber from the first position to a second position. A litter material passes through at least one of one or more screen sections in the chamber and enters a trough. The animal waste is kept out of the trough by a partition and removed to a receptacle through the chamber opening. The method further includes rotating the chamber from the second position to a third position for the litter material to exit the trough. The method further includes rotating the chamber back to the first position for leveling the litter material.

It is to be understood that both the foregoing general description and the following detailed description are exemplary and explanatory only and are not restrictive of the invention, as claimed.

### BRIEF DESCRIPTION OF THE DRAWINGS

FIG. 1 illustrates a front view of a litter collection device, according to certain embodiments of the disclosure.

FIG. 2 illustrates a side view of the litter collection device of FIG. 1, according to certain embodiments of the disclosure.

FIG. 3 illustrates an exploded perspective view of the litter collection device of FIG. 1, according to certain embodiments of the disclosure.

FIG. 4 illustrates another exploded perspective view of the litter collection device of FIG. 1, according to certain embodiments of the disclosure.

FIG. 5 illustrates an interior view of the litter collection device of FIG. 1 without the upper base and top cover, according to certain embodiments of the disclosure.

FIG. 6 illustrates an exploded view of the chamber of FIG. 1, according to certain embodiments of the disclosure.

FIG. 7 illustrates an interior view of the chamber showing the screening of the animal waste from the litter material, according to certain embodiments of the disclosure.

FIG. 8 illustrates an interior view of the litter collection device of FIG. 1 showing the structure of the partition, according to certain embodiments of the disclosure.

FIG. 9 illustrates a perspective view of the receptacle of FIG. 1, according to certain embodiments of the disclosure.

FIG. 10 illustrates a side view of the receptacle of FIG. 1, according to certain embodiments of the disclosure.

FIG. 11 illustrates an exploded perspective view of the receptacle of FIG. 1, according to certain embodiments of the disclosure.

FIG. 12 illustrates a bottom view of the litter collection device of FIG. 1, according to certain embodiments of the disclosure.

FIGS. 13A-13D illustrate a clockwise rotation of the chamber during the first stage of cleaning cycle for separating and dumping the animal waste, according to certain embodiments of the disclosure.

FIGS. 14A-14E illustrate a counterclockwise rotation of the chamber during the second stage of cleaning cycle for reintroducing the litter material to the chamber, according to certain embodiments of the disclosure.

FIGS. 15A-15B illustrate a clockwise rotation of the chamber during the third stage of cleaning cycle for returning to the stand-by position, according to certain embodiments of the disclosure.

FIG. 16 illustrates a microprocessor controller for controlling the litter collection device, according to certain embodiments of the disclosure.

FIG. 17 illustrates a flowchart showing the initialization of the litter collection device of FIG. 1, according to certain embodiments of the disclosure.

FIG. 18 illustrates a flowchart showing the litter emptying cycle of the litter collection device of FIG. 1, according to certain embodiments of the disclosure.

FIG. 19 illustrates a flowchart showing the litter cleaning cycle of the litter collection device of FIG. 1 after being used by an animal, according to certain embodiments of the disclosure.

FIG. 20 illustrates a front view of a manually controlled litter collection device, according to certain embodiments of the disclosure.

FIG. 21 illustrates an exploded perspective view of the manually controlled litter collection device of FIG. 20, according to certain embodiments of the disclosure.

FIG. 22 illustrates a plastic film for attaching to the interior longitudinal wall of the chamber, according to certain embodiments of the disclosure.

FIG. 23 illustrates an exploded view of the chamber with a plastic film attached to the interior longitudinal wall of the chamber of FIG. 1, according to certain embodiments of the disclosure.

FIG. 24 illustrates a perspective view of the litter collection device of FIG. 1 with a plastic film attached to the interior longitudinal wall of the chamber, according to certain embodiments of the disclosure.

FIG. 25 illustrates a perspective view of the receptacle of FIG. 1 when the shutter door is fully closed, according to certain embodiments of the disclosure.

FIG. 26 illustrates an exploded view of the receptacle of FIG. 25, according to certain embodiments of the disclosure.

FIG. 27 illustrates a perspective view of the receptacle of FIG. 1 when the shutter door is moving, according to certain embodiments of the disclosure.

FIG. 28 illustrates an exploded view of the receptacle of FIG. 27, according to certain embodiments of the disclosure.

FIG. 29 illustrates a perspective view of the receptacle of FIG. 1 when the shutter door is fully opened, according to certain embodiments of the disclosure.

FIG. 30 illustrates an exploded view of the receptacle of FIG. 29, according to certain embodiments of the disclosure.

FIG. 31 illustrates a semi-exploded view of the receptacle of FIG. 1, according to certain embodiments of the disclosure.

FIG. 32 illustrates an exploded view of the receptacle of FIG. 1, according to certain embodiments of the disclosure.

FIG. 33 illustrates a perspective view of the receptacle of FIG. 1, according to certain embodiments of the disclosure.

FIG. 34 illustrates a flow chart of an exemplary method for handling an animal waste deposited in a device, according to certain embodiments of the disclosure.

### DETAILED DESCRIPTION

Reference will now be made in detail to the exemplary embodiments, examples of which are illustrated in the accompanying drawings. Wherever possible, the same reference numbers will be used throughout the drawings to refer to the same or like parts.

The following terms are used herein in the specification and appended claims. The term “litter material” as used herein is any granular or particulate material that serves as a waste holding media into which the animal may deposit bodily wastes, such as sand, dried clay, or cat litter. The term “unsoiled litter material” as used herein refers to the litter material that is substantially uncontaminated. The term “animal waste” as used herein means both animal excrement, clumps of litter, and soiled litter material which is the litter material after contacting with animal excrement or urine.

The term “dirty” when used to describe air refers to the air that contains undesirable odors associated with animal waste. The term “clean” when used to describe air refers to the air that is generally odor-free after passing through an odor absorbing filter or being processed to remove the undesirable odors.

When introducing elements of the present disclosure or the preferred embodiments thereof, the articles “a,” “an” and “the” are not intended to denote a limitation of quantity, but rather to denote the presence of at least one of the items being referred to, unless otherwise indicated or clearly contradicted by context. Further, the terms “comprises,” “comprising,” “including” and “having” are intended to be inclusive and mean that there may be additional elements other than the listed elements.

Terms such as “upper,” “lower,” “inner,” “outer,” “front,” “rear,” and variations thereof herein are used for ease of description to explain the positioning of one element relative to a second element, and are not intended to be limiting to a specific orientation or position.

Terms such as “first,” “second,” and variations thereof herein are used to describe various elements, regions, sections, etc. and are not intended to be limiting.

Terms such as “connected,” “in communication with,” “mounted,” and variations thereof herein are used broadly and encompass direct and indirect connections, communication and mountings; and are not restricted to electrical, physical or mechanical attachments, connections, or mountings.

Embodiments of the present disclosure provide an improved litter collection device for separating animal waste using an improved sifting method for filtering the animal waste without posing any danger to the pet animals. It would be preferred for the device to have a chamber with adequate interior space for pet animals so that they can move around when staying inside the device. The device should also have an entry opening that is large enough for pet animals of taller size to poke their head out vertically from the opening of the chamber without being obstructed. It would also be preferred for the device to have means for sanitizing the air inside the device and contain or control the unpleasant odors from the animal waste. Furthermore, other desirable features and characteristics will become apparent from the subsequent detailed description and the appended claims, taken in conjunction with the accompanying drawings and this background of the disclosure.

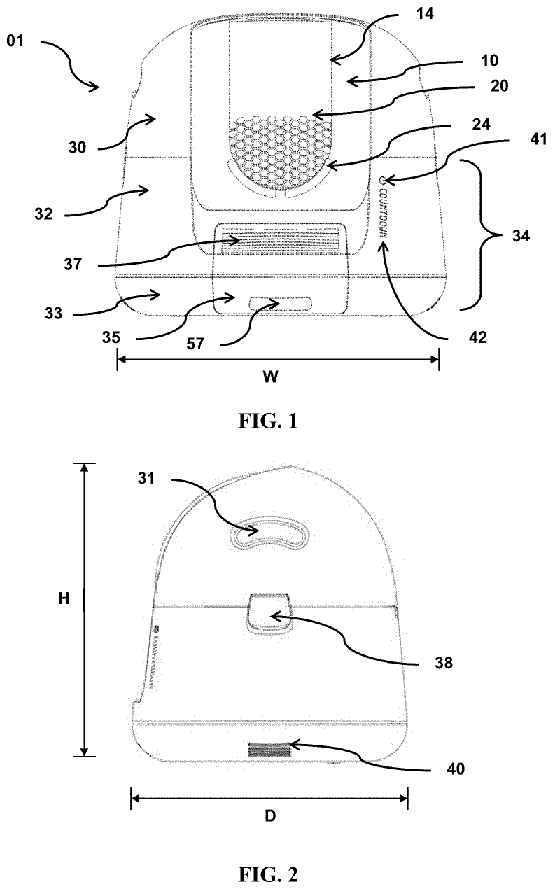

FIG. 1 is a front view of a litter collection device 01 according to the present disclosure, and FIG. 2 is a side view of FIG. 1. Litter collection device 01 can be used for separating litter material 50 (not shown in FIG. 1 or 2) of substantially smaller size from animal waste 51 (not shown in FIG. 1 or 2) of substantially larger size automatically. Litter collection device 01 can also be used for dumping animal waste 51 into a receptacle 35 for disposal. In some embodiments, the particle size of litter material 50 may be of 10 cubic millimeters, 20 cubic millimeters, 30 cubic millimeters or 35 cubic millimeters, while the particle size of animal waste 51 may be of 10 cubic centimeters, 20 cubic centimeters, 30 cubic centimeters or 35 cubic centimeters. It is contemplated that so long as the size of litter material 50 is substantially smaller than (for example, more than 5 times smaller than) animal waste 51, it can be separated from animal waste 51 by litter collection device 01. The particle size of litter material 50 and that of animal waste 51 are not limited to the sizes disclosed above, and they can be of any other size as long as the object of the present disclosure is achieved. The litter collection device 01 may be used by any domesticated animals, such as a cat, dog, ferret, squirrel, rabbit, or other pet animals. In some embodiments, litter collection device 01 may include a top cover 30, a device base 34 and a chamber 10. Device base 34 and top cover 30 may be connected to form an outer shell for litter collection device 01, which may collectively provide a cavity for housing chamber 10. Litter collection device 01 may be sized to fit a domesticated animal into chamber 10 to deposit animal waste 51. For example, litter collection device 01 may be designed to allow a cat to enter into, and move around inside litter collection device 01. In one embodiment, litter collection device 01 has a width of 648.6 mm (W), a depth of 529.7 mm (D), and a height of 594.4 mm (H).

Device base 34 can be disassembled into an upper base 32 and a lower base 33. A cross-sectional shape of device base 34 may be circular, triangular, rectangular, pentagonal, hexagonal, elliptic cylinder, or any other similar shape. Device base 34, which supports chamber 10 on a surface such as a table, floor, slightly inclined plane or rough surface, may be of any size or shape without departing from the spirit of this disclosure. Upper base 32 may be secured on lower base 33 by a plurality of connecting columns 46. Lower base 33 may include a plurality of anti-slippery patterns 40 for increasing the friction between litter collection device 01 and the surface. For example, lower base 33 may include treads and/or a pattern of grooves to increase the friction between litter collection device 01 and the surface.

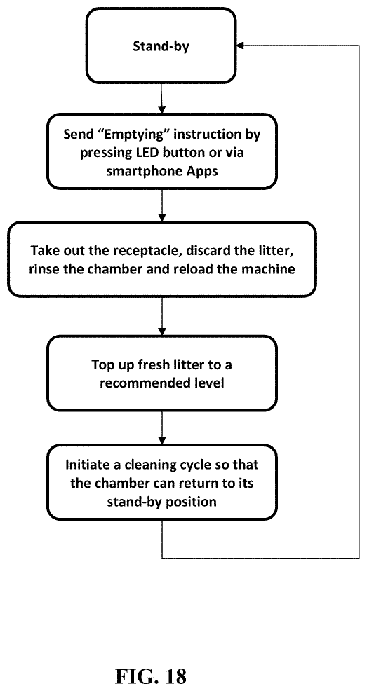

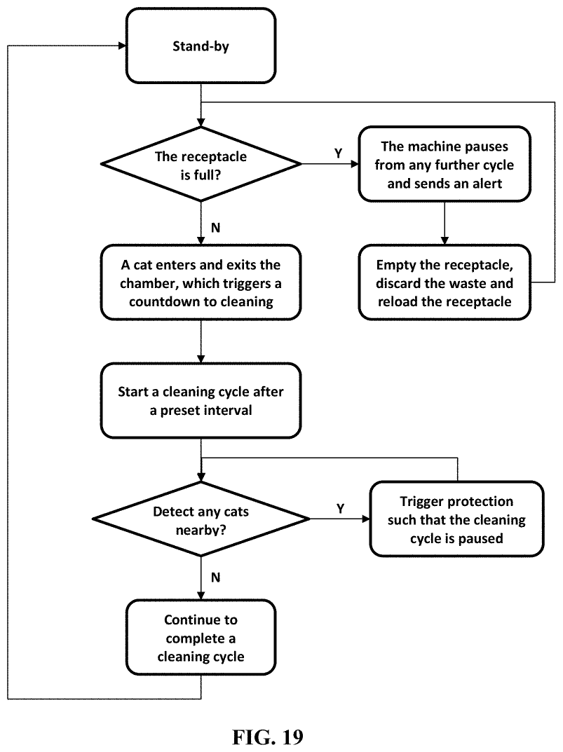

Device base 34 may also include a receptacle 35 such that animal waste 51 can drop thereto when chamber 10 is rotated to a position for dumping animal waste 51. Receptacle 35 may include a plurality of shallow carvings 37 (e.g., treads and/or a pattern of grooves) to form an anti-slippery surface texture that may be used by the animal as the step to enter or exit chamber 10 through chamber opening 14. The plurality of shallow carvings 37 can be made of rubber, plastic, polymer, natural material, synthetic material, or a combination thereof. The plurality of shallow carvings 37 may be inclined by an angle from the vertical plane, and has a rough surface texture so that it is not too slippery for the animal. The range of the angle may be, for example, 30 to 60 degrees, 35 to 65 degrees, or 40 to 70 degrees, etc. In some embodiments, shallow carvings 37 can be a separated platform with an anti-slippery surface for the animal to step in. A doorstep 24 can be attached to chamber opening 14 as an entry passage for assisting smaller animal to step into chamber 10. Doorstep 24 may also include a plurality of holes arranged in rows and columns, in which the animals can clean litter material 50 or other remnants stuck on their paws by rubbing their paws on doorstep 24. Doorstep 24 can remain attached to chamber opening 14 during the litter cleaning cycle (FIG. 19), but may be disassembled during the litter emptying cycle (FIG. 18) such that litter material 50 would not be hindered or prevented from falling into receptacle 35. Receptacle 35 can be opened by a receptacle handle 57. Receptacle handle 57 may be a protrusion connected to receptacle 35 or may be a hollow portion within receptacle 35.

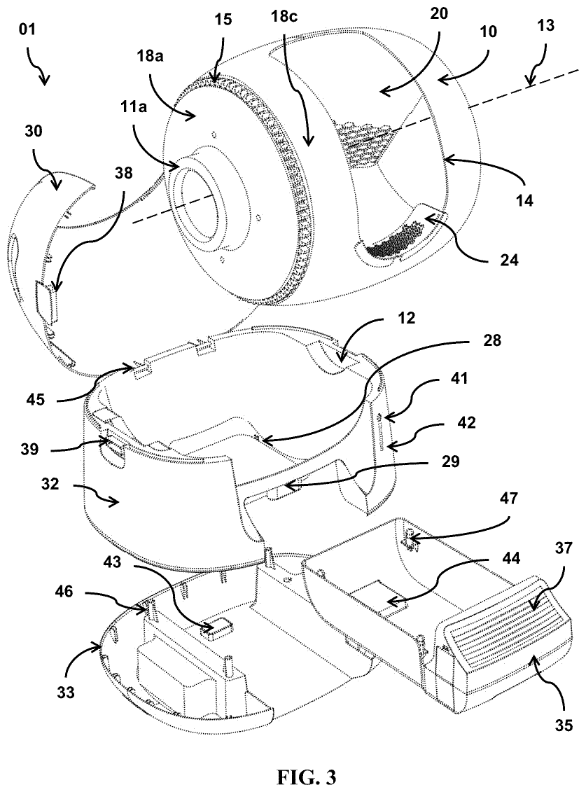

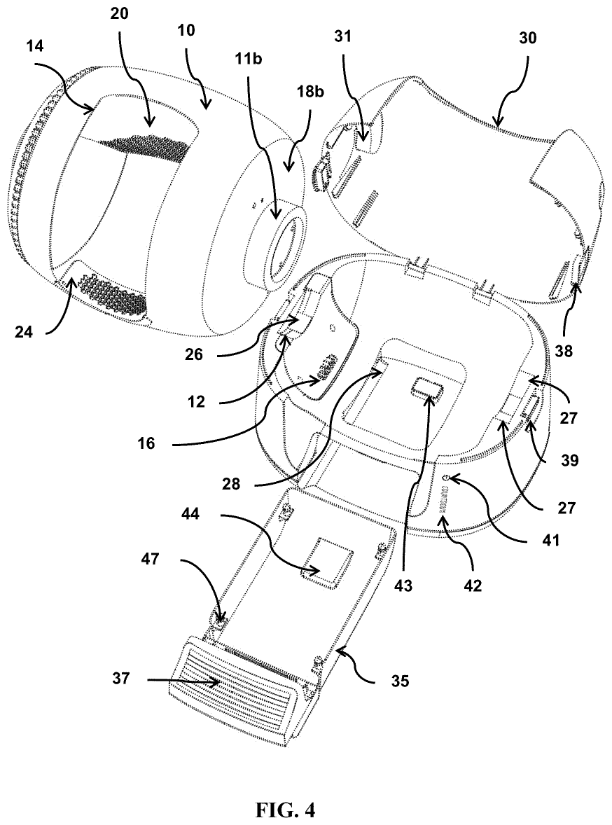

Top cover 30 may be a protective case disposed at the upper portion of litter collection device 01 covering chamber 10. In some embodiments, top cover 30 may include one or more device handles 31 and one or more hinges 45. Top cover 30 can be made from plastic, wood, metal, or transparent material such as glass or acrylic glass. Top cover 30 and device base 34 may be connected via one or more hinges 45 on the rear side of top cover 30. Hinges 45 may be used for pivoting top cover 30 with respect to device base 34, such that top cover 30 may be openable against chamber 10 for preventing the animal from getting inside chamber 10 during rotation. As shown in FIGS. 3 and 4, top cover 30 may further include one or more locking clamps 38. Device base 34 may further include one or more locking protrusions 39 for securing and fastening top cover 30 onto device base 34. It is contemplated that top cover 30 is an optional component. In some embodiments, litter collection device 01 may not have top cover 30, such that chamber 10 is at the top of litter collection device 01.

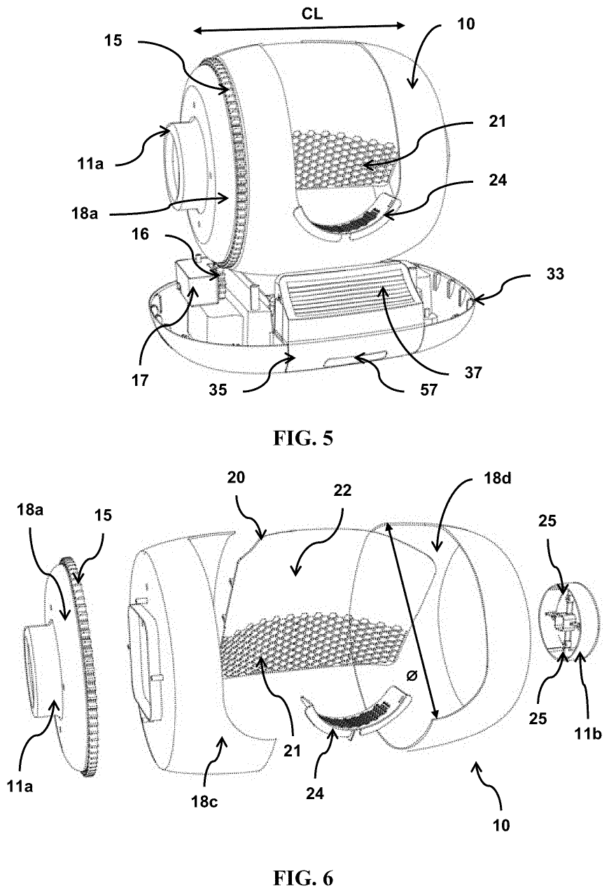

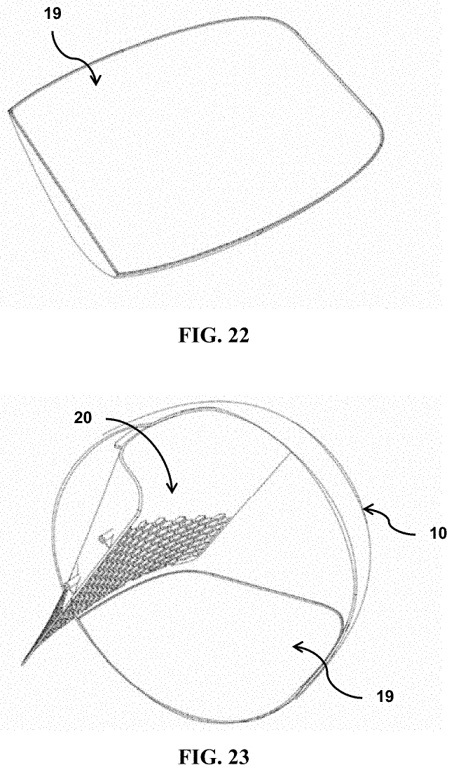

Referring to FIGS. 3 to 6, chamber 10 is located on device base 34 and housed in a cavity enclosed by device base 34 and top cover 30. In some embodiments, chamber 10 may be a semi-open circular chamber in the shape of a barrel with a longitudinal length (CL) in the range of 400 mm to 500 mm. In these embodiments, a cross-sectional diameter (0) of chamber 10 at the middle of the longitudinal side of chamber 10 may be about 460 mm. In some other embodiments, chamber 10 may be shaped like a globe, an arch or a sphere. In some embodiments, chamber 10 is large enough so that most pet animals, including cats or dogs, can fit within chamber 10. In particular, chamber 10 may have a size such that animals with a taller size may poke their head out vertically from chamber opening 14 without being obstructed. Litter material 50 is placed at the inner bottom part of chamber 10. In some embodiments, chamber 10 is partially filled with litter material 50 to a level not higher than the chamber opening 14. For example, chamber 10 may be filled with litter material 50 that approximately occupies one fifth of its whole inner space. Litter material 50 can give the animal a feeling similar to the outdoor environment when depositing animal waste 51 thereon. As shown in FIGS. 22-24, films 19 or other disposable layers may be attached to the interior wall, such as interior longitudinal wall 18d of chamber 10, so that chamber 10 is prevented from being polluted or stuck by litter material 50 or animal waste 51. Chamber 10 may include a partition 20, a gear track 15, a chamber opening 14, a left wheel cap 11a and a right wheel cap 11b. Both left and right longitudinal ends 18a and 18b of chamber 10 are closed, when left longitudinal end 18a of chamber 10 (to the left in FIG. 5) is encircled by a gear track 15. Left wheel cap 11a may be assembled on left longitudinal end 18a, and right wheel cap 11b may be assembled on right longitudinal end 18b. When chamber 10 is rested on device base 34, left and right wheel caps 11a and 11b may be supported by two semi-circular notches 12 of device base 34.

In some embodiments, films 19 (as shown in FIGS. 22-24) may be made from plastic. In other embodiments, films 19 may be made from a specially designed material that consists primarily of glue, silica gel, and hardener. Here, “primarily” means at least 99% of the contents thereof. These three ingredients are mixed and applied to the interior wall of chamber 10. For example, films 19 may be applied on one or both of the bottom (not shown in FIGS. 22-24) and longitudinal wall 18d of chamber 10. Films 19 made from the specially designed material have a superior non-sticky characteristic with respect to litter material 50 and animal waste 51.

In some embodiments, chamber 10 is rotatable about an axis of rotation 13 which may be a horizontal line connecting the center of left wheel cap 11a and the center of right wheel cap 11b through chamber 10, as shown in FIG. 3. Axis of rotation 13 can be defined as a virtual line that is perpendicular to both the vertical plane and the direction of the movement of an animal when entering and exiting chamber 10 through chamber opening 14. The rotation is bi-directional and can be operated manually or automatically. For example, a user of litter collection device 01 (e.g., the pet owner) may manually rotate chamber 10 clockwise or counter-clockwise about axis of rotation 13. In another example, chamber 10 may rotate clockwise or counter-clockwise about axis of rotation 13 automatically according to some pre-programed computer instructions.

In some embodiments, as shown in FIG. 5, the rotation of chamber 10 and the corresponding alternation of orientation are driven by a motor 17 automatically. Gear track 15 on chamber 10 cooperates with a motor gear 16 secured to the output shaft of motor 17. In some embodiments, motor gear 16 lies in the same vertical plane as gear track 15 on the left side of device base 34. A microprocessor controller 60 may be used to control motor 17 by communicating computer instructions to motor 17. Microprocessor controller 60 may be disposed in device base 34. The computer instructions may be automatically generated upon detection of animal movement by sensors, or they may be converted from user instructions. In some embodiments, the computer instructions may determine the angle of rotation and the corresponding orientation of the rotation of chamber 10. It is contemplated that gear track 15 may be placed on right longitudinal end 18b of chamber 10 if motor 17 and motor gear 16 are located on the right side of device base 34. In one embodiment, motor gear 16 may have a module size (m) of 5 with 12 teeth (z), and gear track 15 may have a module size (m) of 5 with 78 teeth (z). It is contemplated that the examples of the spatial location and physical parameters of motor 17, motor gear 16, and gear track 15 disclosed herein are only for illustrative purpose and should not be interpreted in any way that limits the spatial location and physical parameters of these components that would otherwise be compatible with the present disclosure.

In one example, motor 17 may drive motor gear 16 with a turning speed of, for example, 0.065rad/sec, which can complete turning a full cleaning cycle in approximately 97 seconds. The gear ratio of gear track 15 and motor gear 16 may be in a range between about 2 to 20, which amplifies the output torque. The frictional force incurred between left and right wheel caps 11a and 11b and semi-circular notches 12 can be minimized by implementing friction-reducing mechanisms, such as using the circular contact thereof and/or lubricants thereon. Chamber 10 can be rotated to a plurality of positions, including a first position corresponding to a stand-by mode that allows an animal to enter and exit chamber 10 through chamber opening 14, a second position corresponding to a waste dumping mode for removing animal waste 51 from chamber 10, and a third position corresponding to a litter reintroduction mode for reintroducing litter material 50 into chamber 10.

On the front of device base 34, there is an LED button 41 and a display panel 42. LED button 41 may be a control button for controlling litter collection device 01 with various functions, including pausing, triggering a cleaning cycle, triggering an empty cycle and connecting to a portable device via a network, such as a Wi-Fi network, a Wireless Local Area Network (WLAN), a Wide Area Network (WAN), a wireless network using radio waves, a cellular network, a satellite communication network, and/or a local or short-range wireless network (e.g., Bluetooth). In some embodiments, LED button 41 may also be a switch button for switching the power ON/OFF. Display panel 42 may be configured to show the status of litter collection device 01, including countdown, cleaning, emptying, full, error, and pairing (WIFI or Bluetooth), etc. Display panel 42 according to the present disclosure may be implemented using one or more of the following lighting or display devices: a Liquid Crystal Display (LCD) display, a Light-Emitting Diode (LED) display, an Organic Light-Emitting Diode (OLED) display, or any other suitable type of display. Therefore, display panel 42 may provide a Graphical User Interface (GUI) presented on the display for user input and data demonstration. The display of display panel 42 may include a number of different types of materials, such as plastic or glass, and may be touch-sensitive to receive inputs from the user. For example, the display may be covered by a touch-sensitive material that is substantially rigid, such as Gorilla Glass™, or substantially pliable, such as Willow Glass™. Using touch-sensitive displays has the advantage of dispensing the need of additional input buttons.

A sensor unit that includes one or more sensors may be provided within litter collection device 01 and, for example, on the curved surface of each of semi-circular notches 12 in order to detect the position of chamber 10 with respect to device base 34. In some embodiments, as shown in FIG. 4, litter collection device 01 may include one or more Hall Effect sensors 27 that detect the change in a magnetic field. In some embodiments, as shown in FIG. 6, one or more permanent magnets 25 may be disposed on an inner surface of each of left and right wheel caps 11a and 11b. Hall Effect sensors 27 and permanent magnets 25 may be combined to form a position sensor unit for detecting the position of chamber 10 with respect to device base 34, and supplying one or more position signals to microprocessor controller 60. For example, the movement or change of position of permanent magnets 25 disposed on the inner surface of each of left and right wheel caps 11a and 11b may cause a change of magnetic field around Hall Effect sensors 27, which is sensed by Hall Effect sensors 27. Based on the sensing result, Hall Effect sensors 27 may determine the position of chamber 10 with respect to device base 34. It is contemplated that other sensor/sensing mechanism (e.g., a light sensor) may also be used as the position sensor unit. In some embodiments, Hall Effect sensors 27 may also detect the positions of permanent magnets 25 for determining the degree of rotation of chamber 10. Based on the determination, the orientation of chamber 10 may be accurately determined and controlled by microprocessor controller 60.

One or more chamber weight sensors 26 may be disposed at a bottom surface of each of the semi-circular notches 12. The chamber weight sensors 26 may be used to detect any change of weight of the entire chamber 10, either caused by an entry or an exit of the animal or a change of the litter material 50 and/or animal waste 51. Chamber weight sensors 26 may include force collector sensors, piezoresistive strain sensors, capacitive sensors, electromagnetic sensors, optical sensors, force balancing sensors or a combination of two or more thereof. One or more chamber weight signals may be supplied to microprocessor controller 60 for determining whether an animal is present within chamber 10.

As shown in FIGS. 3-4, one or more receptacle weight sensors 43 may be disposed at the bottom of device base 34. For example, when receptacle 35 is properly installed to device base 34, receptacle weight sensors 43 are placed under one or more sensor slots 44, which can be used to detect any change of weight of receptacle 35 and the change of weight of the content therein. Receptacle weight sensors 43 can be a strain gauge, load cell, a force-sensing resistor or a combination of two or more thereof. One or more receptacle weight signals may be supplied to microprocessor controller 60 for determining whether receptacle area 36 is full of animal waste 51. It is noted that the number of receptacle weight sensor 43 may correspond to the number of sensor slots 44 so that each receptacle weight sensor 43 may be under one sensor slot 44, according to some embodiments of the disclosure. In other embodiments though, the number of sensor slots 44 may be more or less than the number of receptacle weight sensors 43, so that sensor slots 44 and receptacle weight sensors 43 do not have a one-to-one configuration.

Also shown in FIGS. 3-4, one or more waste level gauges 28 may be disposed inside device base 34 adjacent to receptacle 35. Waste level gauges 28 may be used to detect the level of waste accumulated in receptacle 35. A waste level gauge 28 may be an infrared sensor, a laser sensor, a camera or a combination of two or more thereof. One or more waste level signals may be supplied to microprocessor controller 60 for determining whether receptacle area 36 is full or substantially full of animal waste 51 or not. “Substantially full” used in these embodiments may have the meaning that more than 80 percent of the volume of receptacle 35 is occupied. In other embodiments, the meaning of “substantially full” may change according to a preset value of litter collection device 01, or a value set by the user.

In order to drive motor 17, sensors, LEDs, microprocessor controller 60 and other electronic parts, electrical power may be supplied to device base 34. The electrical power can be supplied to litter collection device 01 from a battery, a power outlet, or alternatively through a voltage regulator. Interconnecting wiring and cables, power supply housing and other electronic parts may be used in device base 34. For convenience and simplicity, the electrical power and the respective electronic parts have not been shown in the figures.

According to some embodiments, chamber opening 14 may be positioned on a longitudinal wall 18c at the middle of chamber 10, which is a rectangular opening that may have, for example, a height of around 515.4 mm and a width of around 200.6 mm along the circular barrel-shaped surface. In certain embodiments, chamber opening 14 can be made larger in height and top cover 30 can be removed, such that chamber 10 can have no ceiling at the first position. The “no ceiling” arrangement can provide more space for animals of larger size to enter and use litter collection device 01. In particular, animals with taller size may poke their head out vertically from chamber opening 14 without being obstructed.

In some embodiments, chamber opening 14 is operable as an ingress and an egress for the animal to deposit animal waste 51 when chamber 10 is in the first position, and chamber opening 14 is operable as a waste opening for dumping animal waste 51 to receptacle 35 when chamber 10 is rotated by a predetermined angle to the second position such that animal waste 51 may drop down into receptacle 35 in device base 34 by, for example, gravitational force or the force of inertia.

In some embodiments, litter collection device 01 may also include a monitoring system (not shown) for monitoring the animal. For example, when the animal is releasing, the monitoring system in litter collection device 01 may measure the weight, temperature, amount of the released waste, duration of release, or other physical characteristics of the animal. In some embodiments, these measured data may be stored and compared with the prior measurement(s) of the same physical characteristic(s) so that the monitoring system may determine the health of the animal health based on the comparison. Such measured data may be stored in and read from a storage or memory disposed in litter collection device 01, or in the cloud or another system or device via wired or wireless communication links between litter collection device 01 and the cloud or the system or device.

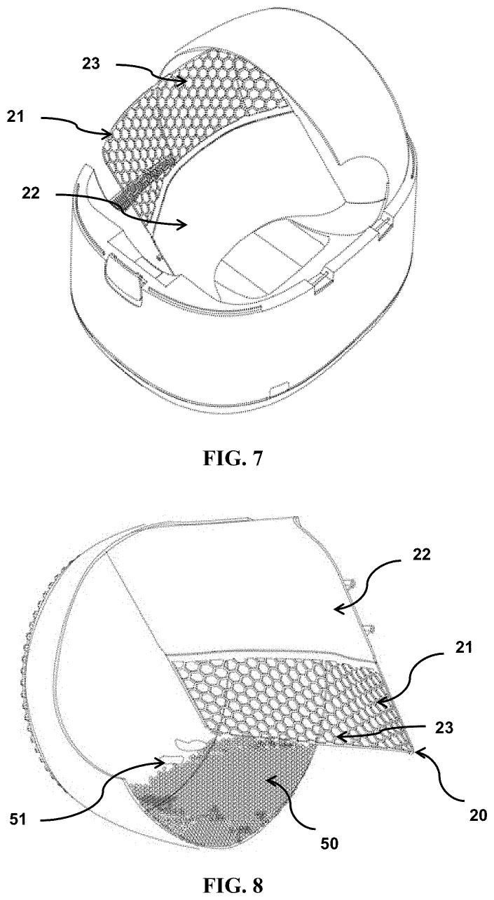

As shown in FIGS. 6 and 7, partition 20 may include one or more screen sections 21, each of which has one or more screen openings 23 thereon, and one or more non-opening sections 22 that have no screen openings. Partition 20 may be generally flat and may be made of plastic, metal or any other suitable material. At least one of non-opening sections 22 of partition 20 may be connected to an interior wall of chamber 10. For example, non-opening sections 22 of partition 20 may be glued, attached to, or otherwise in contact with an interior longitudinal wall 18d of chamber 10 adjacent to chamber opening 14. In some embodiments, partition 20 is not moveable on its own, but may rotate together with and in the same manner as chamber 10. In some embodiments, at least one non-opening section 22 and interior longitudinal wall 18d of chamber 10 may collectively form a trough 52 such that litter material 50 may pass through at least one of screen sections 21 of partition 20, enter trough 52 and be retained inside trough 52. In some embodiments, screen sections 21 of partition 20 may be designed such that animal waste 51 of substantially larger size cannot pass through screen sections 21 (i.e. one or more screen openings 23) of partition 20 while litter material 50 may pass through. Therefore, the animal waste 51 may be retained by screen sections 21, kept out of the trough 52 and separated from litter material 50.

As shown in FIG. 8, a screen opening 23 on a screen section 21 may be sized to permit litter material 50 to pass through, while preventing animal waste 51 with a substantially larger size from passing through. For example, a screen opening 23 may be slightly larger than the size of litter material 50, but substantially smaller than the size of animal waste 51. In some embodiments, a screen opening 23 may have a hexagonal shape with a diagonal between about 10 mm and about 30 mm, or a rounded rectangle shape with a size of about 10 mm×20 mm. Litter material 50 passing through screen openings 23 is unsoiled litter material which is substantially uncontaminated by animal waste 51. Such unsoiled litter material 50 may be retained within trough 52 and recycled for future use when dumping animal waste 51. Unsoiled litter material 50 may be used again when chamber 10 is rotated back to the stand-by position (e.g., the first position).

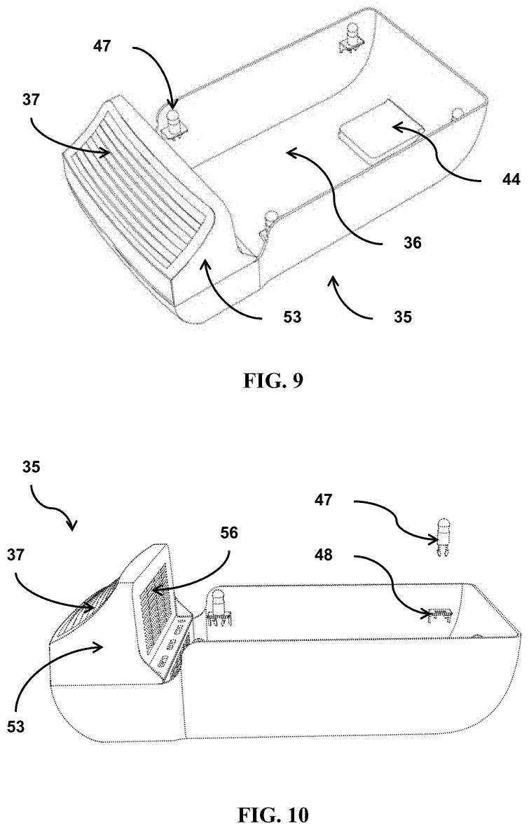

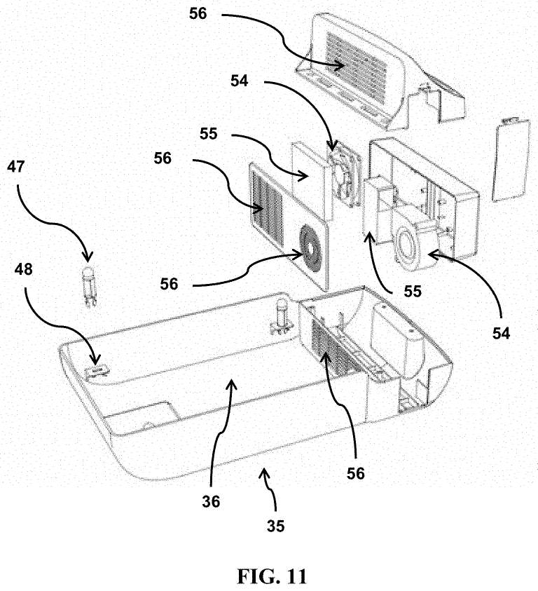

FIGS. 9 and 10 show various views of receptacle 35 according to the present disclosure. In some embodiments, receptacle 35 may include a receptacle area 36, a plurality of connection bolts 47 and an air treatment device, such as a deodorizing unit 53. Receptacle 35 may be adapted to receive one or more storage bags or plastic bags (not shown in the figures) and may further include means for facilitating installation and removal of the storage bags or plastic bags. The installation and removal of the storage bags or plastic bags can be achieved with various mounting devices, such as using one or more connection bolts 47 and one or more connection slots 48. A connection bolt 47 may be attached to its cooperating connection slot 48 inside receptacle area 36, such that the storage bags or plastic bags are mounted within receptacle 35 for collecting animal waste 51 and can be removed from receptacle 35.

In some embodiments, litter collection device 01 may also include a sealing unit for sealing the storage bag when the storage bag is full or substantially full, so that the unpleasant odors from animal waste 51 may be suppressed or prevented from leaking outside when the storage bag is disposed. For example, the sealing unit may use a heat seal mechanism, a plastic wrap, or an interlocking grove and ridge structure to seal the opening of the storage bag when the storage bag is full or substantially full. “Substantially full” used in these embodiments may have the meaning that more than 80 percent of the volume of the storage bag is occupied. In other embodiments, litter collection device 01 may be preset with a threshold value of at least one of the waste level signals that triggers the sealing unit to seal the storage bag, or the user can set up the threshold value on his or her own with respect to the triggering of the sealing unit to seal the storage bag, and the meaning of “substantially full” may change accordingly. The sealing unit may be manually activated by the user, such as by the user pressing a button or instructing the sealing unit via a remote control. The sealing unit may also operate automatically, such as by using a sensor to detect the fullness of the storage bag.

An exemplary internal structure of deodorizing unit 53 according to some embodiments of the present disclosure is illustrated in FIG. 11. In some embodiments, deodorizing unit 53 may be a compact air treatment device that is installed within receptacle 35 for creating a circulation of air within device base 34 and sanitizing the air inside receptacle 35. In some embodiments, deodorizing unit 53 may include one or more fans 54, one or more filters 55, and one or more vents 56. A filter 55 may be an absorbent made of an odor absorbing material, such as an activated charcoal, silica gel, zeolite, or a combination thereof. For example, air circulation within receptacle 35 may be performed from one vent 56 to another vent 56. A filter 55 may be disposed in front of one fan 54 along the air path, such that the air drawn into one vent 56 by fan 54 is filtered by removing the undesirable odors, and expelled out to receptacle 35 through another vent 56. The air expelled from deodorizing unit 53 is generally clean and odor-free. In some embodiments, filters 55 may be anti-bacteria filters, such that deodorizing unit 53 may also minimize the bacteria growth within litter collection device 01.

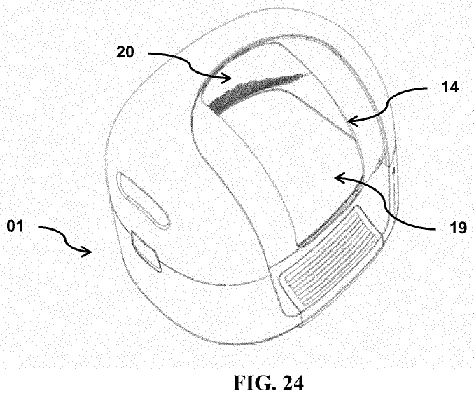

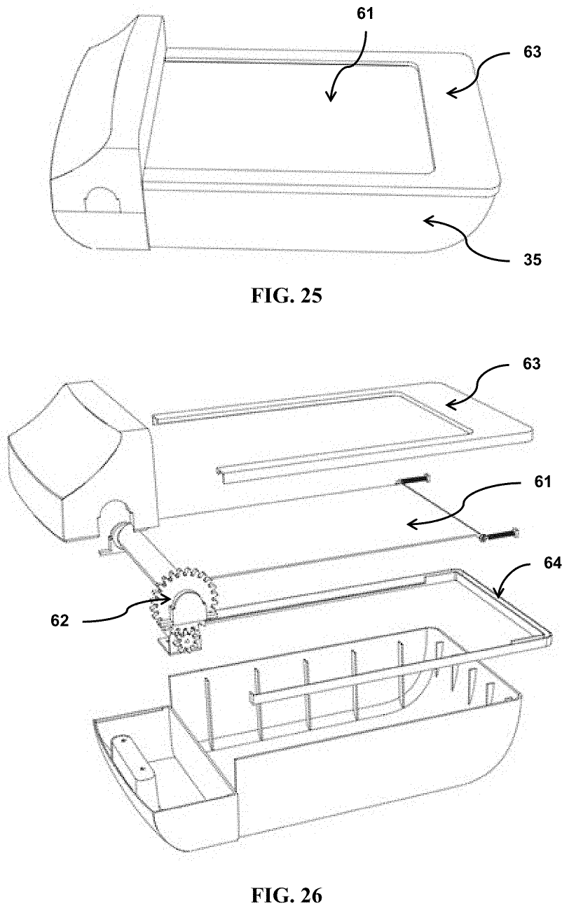

In some embodiments, the air treatment device may only include odor-absorbing materials, without the structure of vents 56, filters 55 and fans 54 discussed above. In one example, the odor-absorbing materials may be replaceable via a cover or an opening (not shown) at the front of receptacle 35. In other examples, they may also be reachable from other side (e.g., surrounding, up, or down) of receptacle 35 upon design choice of a person of skill in the art and not limited to the front side of receptacle 35. In other embodiments, the air treatment device may include an air refresher that releases aroma or neutralizing spray by squeezing a soft container of aroma liquid or air to reduce the unpleasant odors and fresh the air. For example, the air refresher can automatically release aroma or neutralizing spray upon the rolling up of shutter door 61 (to be discussed in FIGS. 25-32). The release may also be set periodically at a time interval preset by the user. The release may further be set to start before the user cleans up receptacle 35.

In some embodiments, litter collection device 01 may also include an animal waste processing equipment. The animal waste processing equipment may be provided at an end of receptacle 35 or below receptacle 35. For example, the animal waste processing equipment may include at least one of a dehydrator, a dryer, and/or a grinder. The processing greatly reduces the odors of animal waste 51 and also prevents fermentation of animal waste 51 when left unattended for a long period of time.

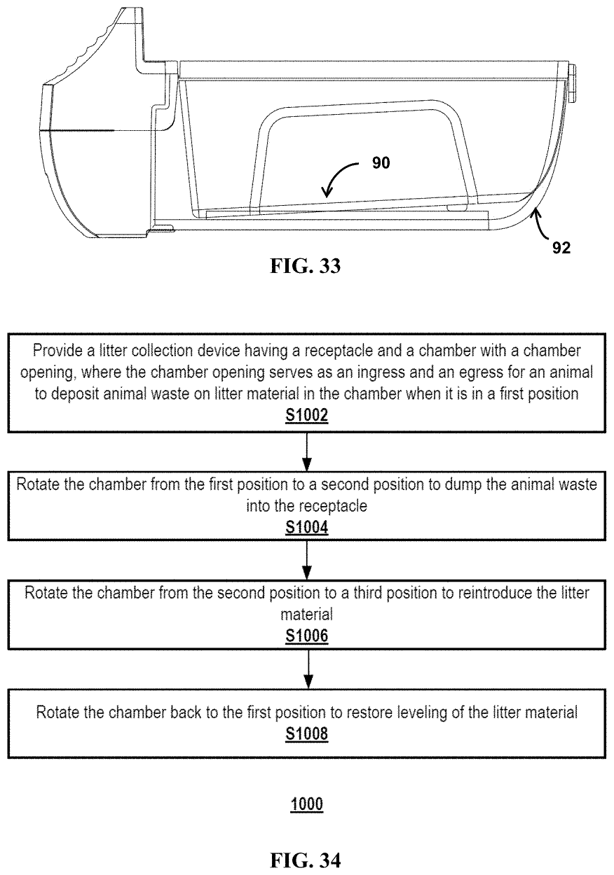

FIG. 33 illustrates a perspective view of receptacle 35 configured to have a slope structure, according to some embodiments of the present disclosure. The exemplary receptacle 35 in FIG. 33 is designed to have its back end 92 elevated to form a slope 90. This allows animal waste 51 to gradually move or slide to the lower portion of the slope, and thus will not pile up in the center area of receptacle 35. As a result, the user does not have to clean up receptacle 35 as often as he or she needs with respect to a design of flat bottom of receptacle 35. In some embodiments, receptacle 35 may include a sweeper (not shown), sweeping back-and-forth, left-and-right, or between selected directions, so that animal waste 51 may be swept to the lower portion of the slope of receptacle 35. In other embodiments, a fan may be provided at the higher portion of the slope in order to blow the piled up animal waste 51 to the lower portion of the slope. In embodiments where a waste processing equipment is provided, the lower portion of the slope may be connected with the animal waste processing equipment, so that animal waste 51 may be processed before it piles up in receptacle 35.

According to other embodiments of the present disclosure, receptacle 35 may have a swaying mechanism. The swaying mechanism may cause receptacle 35 to sway intermittently in order to avoid pile-up of animal waste 51. In one preferred embodiment, the swaying mechanism may start to sway immediately after a dumping cycle is over or shutter door 61 is closed.

According to further embodiments of the present disclosure, the path for dumping animal waste 51 from chamber 10 to receptacle 35 may be provided with a valve that may control the size and position of an opening of the path, thus avoiding piling up of animal waste in a particular spot in receptacle 35. For example, the position of the opening may first be located near the center area of receptacle 35, and after a predetermined number of times of dumping (e.g., 1, 2, or 3), the opening may be relocated to one of the four corners of receptacle 35. Subsequent re-positioning of the opening is also possible according to the present disclosure. The size of the opening may be first configured to be a circle having a diameter equal to the width of receptacle 35, and may be reduced subsequently upon re-positioning of the opening.

In some embodiments, litter collection device 01 may also include an air conditioning device, such as an AC or a dehumidifier. An AC may lower the air temperature of receptacle 35, and a dehumidifier may keep the air dry within receptacle 35. Dry and cool air may help suppress fermentation of animal waste 51. This is a significant improvement from conventional animal potty devices because it allows the animal owner to leave home for a much longer period of time without worrying about the unpleasant smell of animal waste 51 that may accumulate if left unintended or without proper treatment.

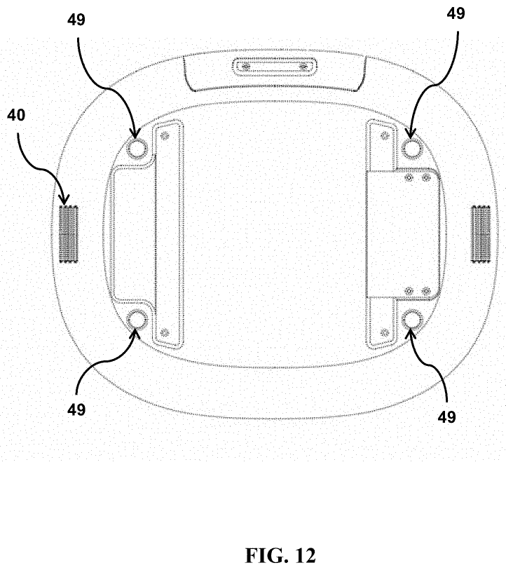

FIG. 12 shows a bottom view of litter collection device 01. One or more device weight sensors 49 may be disposed at the bottom of litter collection device 01 and in contact with the bottom surface. A device weight sensor 49 can be a strain gauge, load cell, a force-sensing resistor or a combination of two or more thereof. Device weight sensors 49 may be used to detect any change of weight of the entire litter collection device 01, either caused by an entry or an exit of the animal, a change of litter material 50, or a disposal of waste material 51 to receptacle 35. One or more device weight signals may be supplied to the microprocessor controller 60 when weight changes have been detected.

In some embodiments, litter collection device 01 may further include one or more presence sensors 29 for detecting a presence or an absence of the animal within a predetermined distance from chamber 10. A presence sensor 29 can be a microwave radar, an ultrasonic sensor, an infrared sensor, a camera, a thermal imaging sensor, a millimeter-wave radar, a laser sensor or a combination of two or more thereof. One or more presence signals may be supplied to microprocessor controller 60 to determine the presence or absence of the animal within the predetermined distance from chamber 10. For example, the predetermined distance may be 10 cm, 20 cm, 30 cm, 50 cm or 1 m. Presence sensors 29 may supply one or more presence signals to microprocessor controller 60 when it determines the presence or absence of the animal within the range.

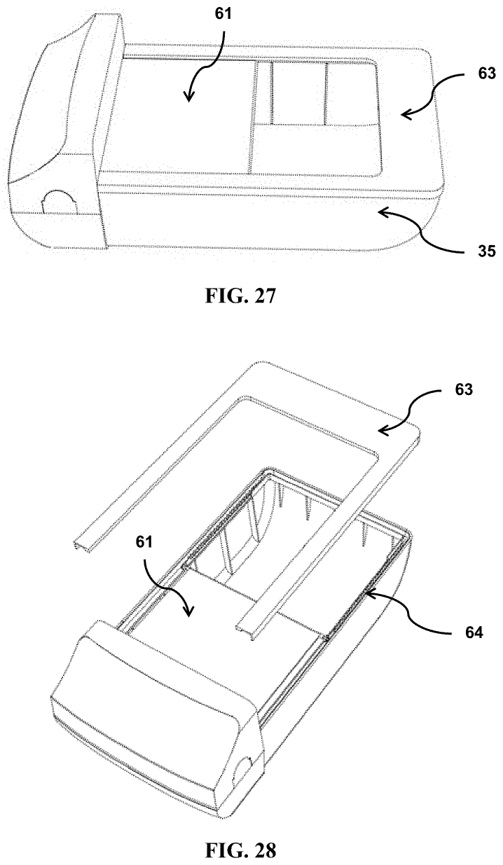

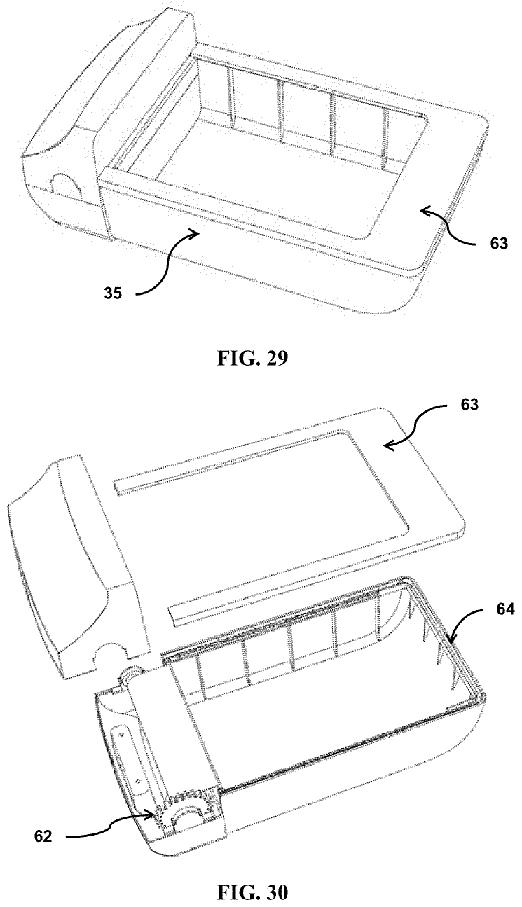

FIG. 25 is a simplified view illustrating receptacle 35 with a shutter door 61 fully closed. FIG. 27 illustrates a perspective view of receptacle 35 when shutter door 61 is moving and FIG. 29 illustrates a perspective view of receptacle 35 when shutter door 61 is fully opened. The respective exploded views are illustrated in FIG. 26, FIG. 28 and FIG. 30. In some embodiments, shutter door 61 can be an add-on component that can be used to contain or control the unpleasant odors from animal waste 51 in receptacle 35. A shutter track 64 may be a track allowing shutter door 61 to move along. Shutter track 64 may be disposed at the top of receptacle area 36. Shutter door 61 may be extended from one end of receptacle area 36 to an opposite end of receptacle area 36 (shown in FIGS. 9 and 11). In some embodiments, the movement of shutter door 61 may be driven by a plurality of shutter gears 62 and a shutter motor (not shown in FIGS. 25-30), controlled by microprocessor controller 60. A shutter cover 63, for example, with a shape of the letter “U”, is positioned above shutter door 61. When closed, shutter cover 63 and shutter door 61 may collectively form an airtight partition for preventing the unpleasant odors of animal waste 51 from entering other area of chamber 10 or any other parts of litter collection device 01.

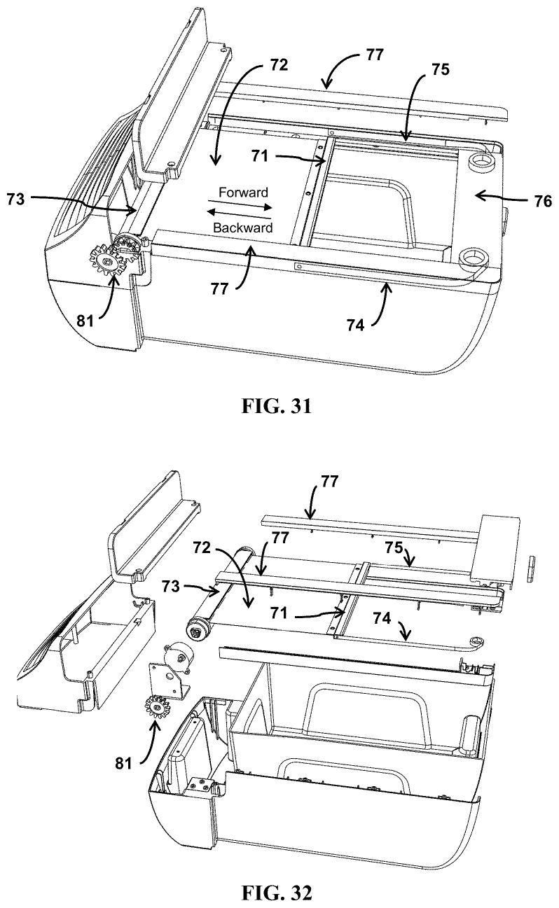

FIGS. 31 and 32 respectively illustrate a semi-exploded view and an exploded view of receptacle 35, according to some further embodiments of the present disclosure. In some embodiments, as illustrated in FIG. 31, shutter door 61 may include a rod 71 on one end of shutter door 61 that is attached to a shutter cover 72 so that shutter cover 72 moves along with rod 71 when shutter door 61 is rolling forward (to close shutter door 61) or backward (to open shutter door 61). Shutter door 61 may also include a receiving storage 73 on the other end for storing the rolled-up shutter cover 72 when shutter door 61 is being opened. A first spring 74 and a second spring 75 may be disposed on each side of rod 71. One end of first spring 74 may be connected to an end of rod 71, while the other end of first spring 74 may be clamped with a side wall 76 of receptacle 35. Similarly, one end of second spring 75 may be connected to the other end of rod 71, while the other end of second spring 75 may be clamped with side wall 76 with a distance from the other end of first spring 74. Both first and second springs 74 and 75 may be covered under side bars 77 of receptacle 35 to prevent external damage to the springs. As shutter door 61 rolls forward, springs 74 and 75 may retract; as shutter door 61 rolls backward, springs 74 and 75 may extend.

According to some embodiments of the present disclosure, the material of shutter cover 72 may be polyvinyl chloride (PVC) or plastic. The current disclosure does not limit the door materials to these two alone. As long as the material can keep shutter cover 72 elastic and be able to substantially prevent the unpleasant odors from leaking out of receptacle 35 when closed, a person of skill in the art would know how to apply that material to the present disclosure.

Consistent with the present disclosure, the open and close of shutter door 61 can be automatic. In some embodiments, the rolling of shutter door 61 may be driven by a shutter motor 81. One example of shutter motor 81 is a step motor. The rolling distance of shutter door 61, as well as the position of rod 71, can be calculated by the rolling time and rotation speed of the step motor. In some embodiments, shutter motor 81 may be activated when chamber 10 starts to rotate from the first position in order to dump animal waste 51 to receptacle 35. In some other embodiments, the rolling speed of shutter door 61 may be set to be equal to or faster than a speed at which the shutter door 61 becomes fully open when chamber 10 rotates to the second position. Therefore, animal waste 51 will not be dumped on top of shutter cover 72. When chamber 10 starts rotating away from the second position, shutter motor 81 may be activated again, but in a different direction, to close shutter door 61. The closing of shutter door 61 may start immediately after chamber 10 starts rotating away, or after a short time interval (e.g., 1 second, 2 seconds, 3 seconds, etc.). This can minimize the dispersion of unpleasant odors of animal waste 51. In some embodiments, a switch (not shown) may be provided to detect the rotation steps and hold the rotation of shutter motor 81 when shutter door is fully open or fully closed.

FIG. 34 illustrates a flow chart of an exemplary method for handling an animal waste deposited into a litter collection device, according to embodiments of the disclosure. The litter collection device may be the same as litter collection device 01 described in the present disclosure, which includes chamber 10 with chamber opening 14. At step S1002, chamber opening 14 may be operable as an ingress and an egress for the animal to deposit animal waste 51 when chamber 10 is in the first position. Chamber opening 14 may be operable as a waste opening for dumping animal waste 51 to receptacle 35 when chamber 10 is rotated by a predetermined angle to the second position such that animal waste 51 may be dropped into receptacle 35 in device base 34, as discussed in conjunction with step S1004. The structure of partition 20 may include one or more screen sections 21, each of which has one or more screen openings 23 thereon, and one or more non-opening sections 22. Therefore, partition 20 may screen animal waste 51 from litter material 50 through the movement of chamber 10. After animal waste 51 is dumped into receptacle 35, chamber 10 may be rotated by a second angle to third position for reintroducing litter material 50, as discussed in conjunction with step S1006, and then by a third angle back to the stand-by position for leveling litter material 50, as discussed in conjunction with step S1008.

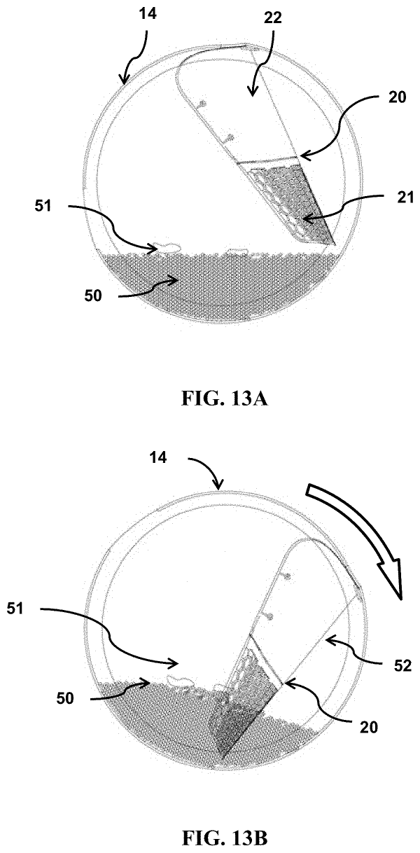

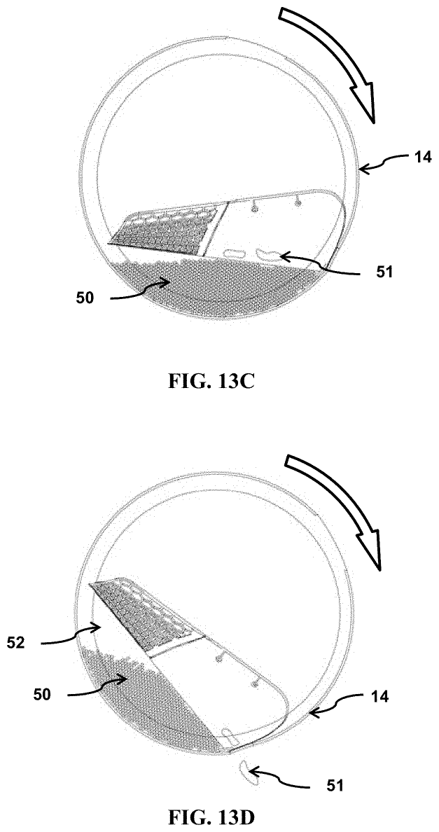

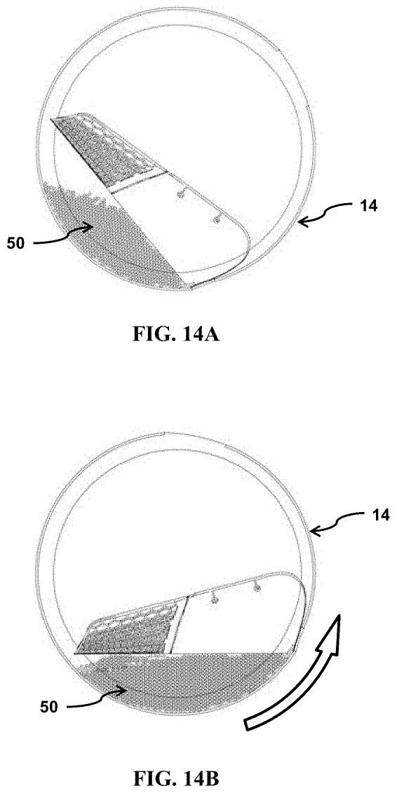

In some embodiments, during the litter cleaning cycle, the litter collection device 01 can be seen to operate as follows and as is shown in FIGS. 13A-13D, 14A-14E and 15A-15B. The stand-by position of chamber 10 is illustrated in FIG. 5 and the cross-sectional view thereof is illustrated in FIG. 13A. A desired quantity of litter material 50 can be placed into chamber 10. The animal may enter chamber 10 through chamber opening 14 and deposits animal waste 51 into litter material 50 when chamber 10 is in the stand-by position as shown in FIG. 13A.

At step S1004, when litter collection device 01 begins a litter cleaning cycle, chamber 10 may be rotated by a first angle from the stand-by position as shown in FIG. 13A to a waste dumping position (second position) as shown in FIG. 13D in a clockwise direction (as viewed in FIGS. 13B-13D). The first angle may be in the range of 120° to 180°, 100° to 160°, 90° to 150°, 110° to 170°, or 130° to 190° clockwise. For example, the first angle may be 150° clockwise. During the rotation, litter material 50 may slide along the internal surface of chamber 10 by the gravitational force, pass through screen sections 21 and enter trough 52. Concurrently, animal waste 51 with a substantially larger size is too large to sift through screen openings 23, so that animal waste 51 will continue to slide through screen sections 21 and be kept out of trough 52 by partition 20. When chamber opening 14 is rotated to a position above receptacle 35, animal waste 51 will then drop out through chamber opening 14 to receptacle 35 by the gravitational force. Thereby, animal waste 51 may be separated from litter material 50 by partition 20. As shown in FIGS. 13C and 13D, litter material 50 may be trapped within trough 52 and can thus be reused.

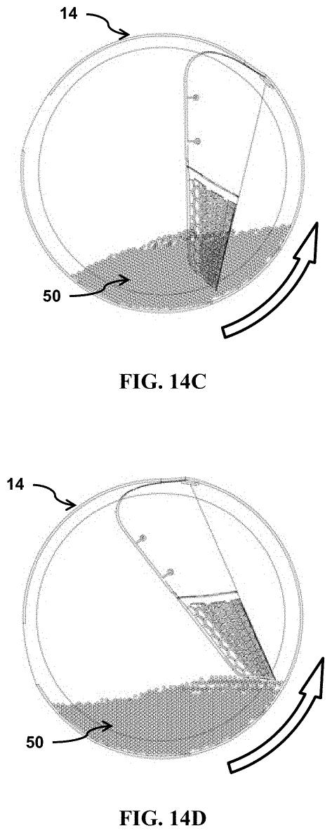

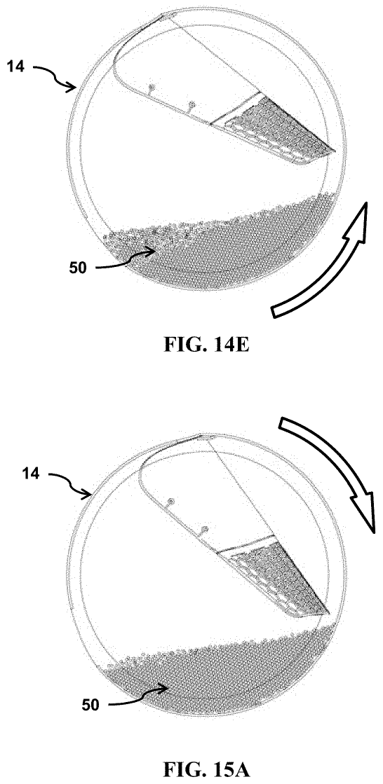

At step S1006, after dumping animal waste 51 into the receptacle 35, chamber 10 may be rotated in an opposite direction by a second angle (counterclockwise as viewed in FIGS. 14A-14E) to a third position. The second angle may be in the range of 145° to 205° counterclockwise. For example, the second angle may be 175° counterclockwise. By doing so, litter material 50 may be reintroduced such that it passes through screen sections 21 for the second time and may leave trough 52. Thus, trough 52 may be emptied when chamber 10 is rotated to the third position as shown in FIG. 14E. For example, litter material 50 may exit trough 52 when chamber 10 rotates from the second position to a third position. It can be appreciated that, instead of being dropped directly from a significant height to the bottom of chamber 10, litter material 50 can smoothly slide along the inner surface of chamber 10. This reduces the probability that litter material 50 escapes chamber 10 and the need to refill litter material 50. Alternatively, when chamber 10 rotates clockwise to the third position, litter material 50 would first be trapped temporarily in trough 52 as it cannot pass through the wall of non-opening sections 22, and then be dropped from a significant height to the bottom of chamber 10 when partition 20 is rotated to the top before chamber 10 reaches the third position as shown in FIG. 14E. This is a more speedy solution as compared to the other embodiments as discussed immediately above.

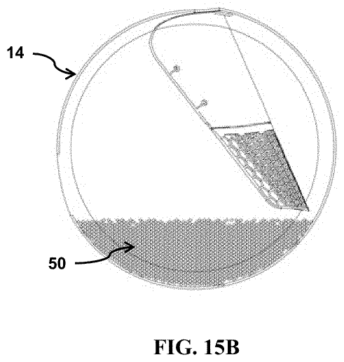

At step S1008, after reintroducing litter material 50, chamber 10 may be rotated clockwise by a third angle (as viewed in FIGS. 15A-15B) for restoring the stand-by position (FIG. 15B). Thus, litter material 50 may be leveled to the position before the animal deposited the waste. For example, the third angle may be 25° clockwise or any angular difference between the first angle and the second angle. This would enable the animal to enter chamber 10 again at the first position via chamber opening 14 to deposit animal waste again.

In some embodiments, litter collection device 01 may further include a flushing device for flushing receptacle 35 in order to remove animal waste 51 from receptacle 35. The flushing device may use liquid (e.g., water or diluted detergent) or airflow to flush animal waste 51 deposited into receptacle 35. The flushing device may have a container that contains such liquid, which may be refilled from time to time. Receptacle 35 may have an inlet connected with an airflow supply or a liquid supply (such as a water tap). Receptacle 35 may have an outlet connected with an inlet of a home sewage, so that animal waste 51 may be conveniently flushed away from litter collection device 01. Litter material 50 in these embodiments are preferred to include decomposable materials, such as corn grains or tofu dregs. It may further include a dryer in or near receptacle 35 to dry up the inside of receptacle 35 after receptacle 35 is flushed by liquid.

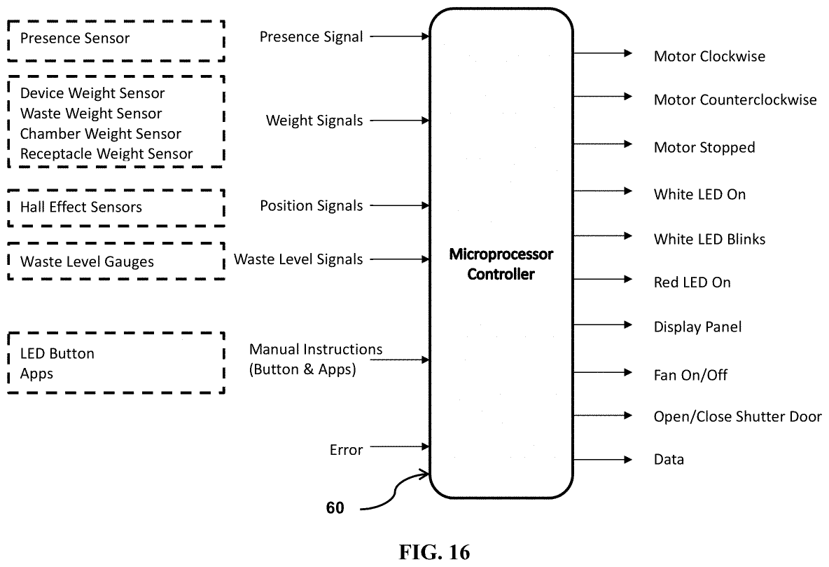

As shown in FIG. 16, microprocessor controller 60 for controlling the litter collection device 01 is illustrated. Microprocessor controller 60 may be implemented using general purpose or specialized computing devices, encompassed within a microcontroller unit (MCU), a custom integrated circuit, a digital signal processors (DSP), a field-programmable gate array (FPGA), an application specific integrated circuits (ASIC), a central processing unit (CPU), a graphics processing unit (GPU), a computer device to perform a method, a programmable I/O device, other semiconductor devices, or any suitable combination of the foregoing for executing a method for controlling litter collection device 01 in accordance with the methods described herein.

In some embodiments, microprocessor controller 60 may receive at least one input signal from a plurality of sensors. The at least one input signal may include one or more of presence signals, weight signals, position signals, waste level signals, or a combination of two or more thereof. The presence signals are supplied by presence sensor 29. The weight signals, including one or more weight signals regarding the weight of chamber 10, one or more receptacle weight signals, and one or more device weight signals, may be supplied by chamber weight sensors 26, receptacle weight sensors 43, and device weight sensors 49 respectively to microprocessor controller 60. The position signals may be supplied by the Hall Effect sensors 27. The waste level signals are supplied by the waste level gauges 28.

In some embodiments, microprocessor controller 60 may also receive manual instructions from LED button 41 and/or signals from a user interface (for example, an Application (App)) installed on a smart device, such as a tablet or a smartphone. LED button 41 may allow control of litter collection device 01 by various actions, such as a single press, a press and held, a double-press or a combination of two or more thereof. When litter collection device 01 is controlled by the App, data transmissions can be established between the smart device and litter collection device 01, via a network, such as a Wi-Fi network, a Wireless Local Area Network (WLAN), a Wide Area Network (WAN), a wireless network using radio waves, a cellular network, a satellite communication network, and/or a local or short-range wireless network (e.g., Bluetooth). When there is any malfunction detected, microprocessor controller 60 can also receive an error signal, which can immediately put the operation in pause until a further action is taken by the user.

In some embodiments, microprocessor controller 60 responds to the foregoing input signals to provide a plurality of output signals, including a motor control signal for rotating the motor 17 clockwise, or counterclockwise, a motor stop signal, a white LED enable/blinking signal for controlling the white LED in LED button 41, a red LED enable signal for turning LED button 41 on with a red color, a plurality of control signals for driving the display panel 42, an enable signal for turning fan 54 on/off, an enable signal for closing/opening shutter door 61, and other data signals for data recording.

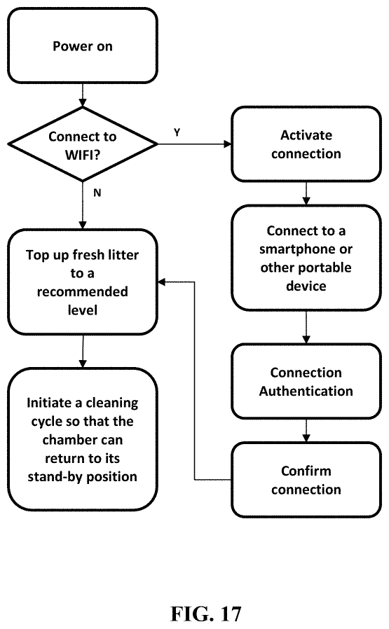

FIG. 17 is a flowchart showing the initialization of the litter collection device 01. Upon powering on litter collection device 01, litter collection device 01 can first be connected to a smartphone by a Wi-Fi connection. The user can then top up fresh litter material 50 to chamber 10 to a recommended level. For example, the recommended level of litter material 50 may be not higher than the chamber opening 14.

FIG. 18 is a flowchart showing a litter emptying cycle of litter collection device 01 for dumping litter material 50. When litter material 50 needs to be changed from time to time, the user may manually trigger an empty instruction to litter collection device 01 via a user interface, such as a user interface in a smartphone, or by pressing LED button 41. Under the empty instruction, chamber 10 may be rotated in a counterclockwise manner (opposite direction as the rotation in the litter cleaning cycle) and litter material 50 will fall into receptacle 35. The user can remove litter material 50 by removing receptacle 35, discarding the content therein, rinsing chamber 10, and reloading receptacle 35 back to the litter collection device 01. Litter material 50 can then be refilled to a recommended level, and the user can initiate a new cleaning cycle so that chamber 10 can be returned to its stand-by position.

FIG. 19 is a flowchart showing the automatic litter cleaning cycle of litter collection device 01 after being used by an animal. Waste level gauges 28 and receptacle weight sensors 43 may first determine a waste level of receptacle 35, such that litter device 01 may be paused from any further cycle and may provide an alert to the user if receptacle 35 is full. After the animal enters and subsequently exits chamber 10 through chamber opening 14 when chamber 10 is in the stand-by position, a countdown, e.g., a 10-minute countdown, may be triggered for initiating a cleaning cycle. The countdown for a preset interval allows sufficient time for litter material 50 to clump with/mixed up with the urine of the animal. In some embodiments, the preset interval is about 10 minutes. Presence sensor 29 may then determine whether an animal is within a predetermined distance from chamber 10. A chamber weight sensor 26 and a device weight sensor 49 may determine whether an animal is within chamber 10. If an animal is detected to be within chamber 10 or within a predetermined distance from chamber 10, a protection procedure may be triggered such that the litter cleaning cycle may be paused until no animal is detected. Chamber 10 is then rotated by a first angle from the stand-by position to the waste dumping position (FIGS. 13A-13D) such that the animal waste 51 may be separated from the litter material 50 by partition 20 and may be dropped to receptacle 35 through chamber opening 14 by gravitational force. After dumping animal waste 51, chamber 10 may rotate in an opposite direction by a second angle (FIGS. 14A-14E) to a third position for reintroducing litter material and rotate by a third angle (FIGS. 15A-15B) for restoring the stand-by position.

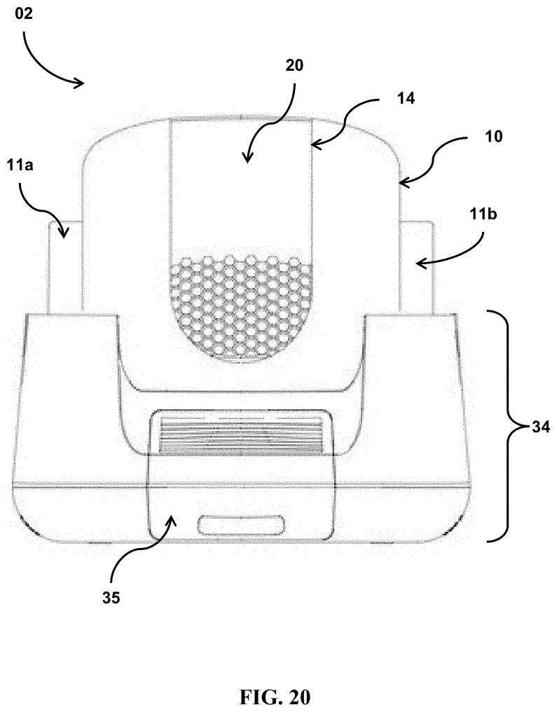

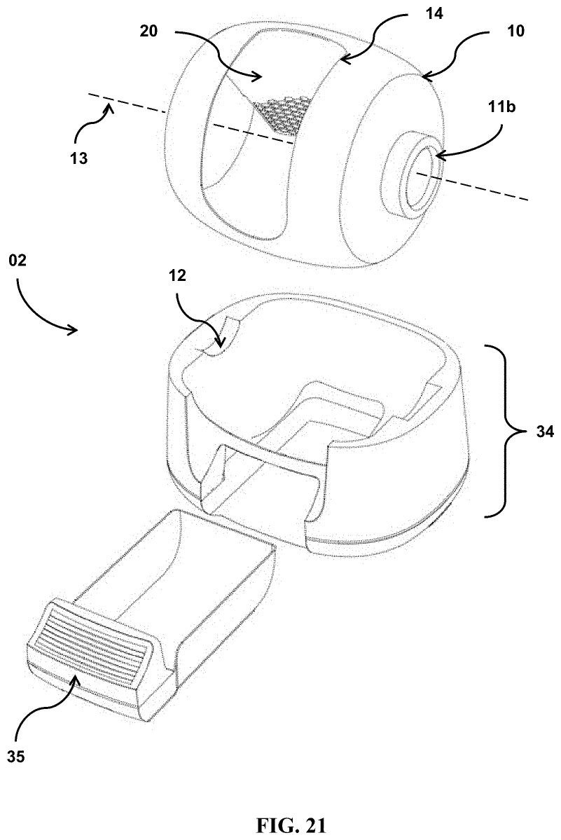

In accordance with an alternative embodiment, the present disclosure also provides a manually controlled litter collection device 02 as depicted in FIGS. 20-21. The manually controlled litter collection device 02 can be used for separating litter material 50 of substantially smaller size from animal waste 51 of substantially larger size by a manual movement of chamber 10 and dumping animal waste 51 into a receptacle 35 for disposal. In some embodiments, the manually controlled litter collection device 02 may include a device base 34 and a chamber 10. Chamber 10 may include a partition 20, a chamber opening 14, a left wheel cap 11a and a right wheel cap 11b. Chamber 10 may be disposed on device base 34 and is rotatable about an axis of rotation 13. When chamber 10 is rested on device base 34, left and right wheel caps 11a and 11b may be supported by two semi-circular notches 12. Axis of rotation 13 may be a horizontal line through the chamber from the center of left wheel cap 11a to the center of right wheel cap 11b, which can be defined as a virtual line that is perpendicular to both the vertical plane and the direction of the movement of an animal when entering and exiting chamber 10 through chamber opening 14. For ease of illustration, same or similar components illustrated in litter collection device 01 are not repeated in the description.

It is contemplated that the rotation of chamber 10 can be bi-directional, such as clockwise and counterclockwise. Also the rotation can be operated by manually turning chamber 10 to a plurality of positions. For example, chamber 10 may be manually turned to a first position corresponding to the stand-by position that allows an animal to enter and exit chamber 10 through chamber opening 14, a second position corresponding to the waste dumping position for removing animal waste 51 from chamber 10, and a third position corresponding to the litter reintroduction position for reintroducing litter material 50 into chamber 10.

Accordingly, various structures, devices, and methods for separating a litter material from an animal waste deposited by an animal, and dumping the animal waste are provided. While exemplary embodiments have been presented in the foregoing detailed description of the invention, it should be appreciated that a vast number of equivalent variations exist. It should also be appreciated that these exemplary embodiments are only examples, and are not intended to limit the scope, applicability, or configuration of the invention in any way. Rather, the foregoing detailed description will provide those skilled in the art with a convenient road map for implementing an exemplary embodiment of the invention. Various changes may be made in the function and arrangement of elements described in an exemplary embodiment without departing from the scope of the invention as set forth in the appended claims and their legal equivalents.

What is claimed is:

1. A device for handling an animal waste deposited by an animal, the device comprising:
a device base comprising a receptacle; and
a chamber located on the device base, wherein the chamber is rotatable about an axis of rotation and comprises:
a chamber opening being operable as an ingress for the animal to deposit the animal waste when the chamber is in a first position and being operable as a waste opening for dumping the animal waste to the receptacle when the chamber is in a second position; and
a partition located within the chamber, wherein the partition comprises:
one or more screen sections, each having one or more screen openings thereon; and
at least one non-opening section being connected to an interior wall of the chamber, wherein the non-opening section and the interior wall of the chamber form a trough for temporarily storing a litter material;
wherein when the chamber is rotated from the first position to the second position, the litter material passes through at least one of the screen sections and enters the trough, and the animal waste is kept out of the trough by the partition and removed to the receptacle through the chamber opening; and
wherein when the chamber is rotated from the second position to a third position, the litter material exits the trough.

2. The device of claim 1, wherein the receptacle comprises a shutter door and one or more rotatable shutter gears configured to open and close the shutter door.

3. The device of claim 2, wherein the shutter door extends from a first end of the receptacle to a second end of the receptacle opposite to the first end.

4. The device of claim 1, further comprising a film disposed within the chamber configured to protect an interior surface of the chamber from being polluted by the litter material or the animal waste.

5. The device of claim 4, wherein the film is made from a material that consists primarily of glue, silica gel, and hardener.

6. The device of claim 1, wherein the receptacle is adapted to receive one or more storage bags and further comprises a mounting device configured to facilitate installation or removal of the storage bags.

7. The device of claim 6, further comprising a sealing unit configured to seal the storage bag when the receptacle is full or substantially full.

8. The device of claim 1, further comprising an air treatment device configured to create a circulation of air within the device base and sanitize air inside the receptacle.

9. The device of claim 1, further comprising a motor configured to rotate the chamber and altering the orientation of the rotation.

10. The device of claim 9, further comprising a top cover configured to cover the chamber, wherein the top cover comprises one or more hinges configured to pivot the top cover with respect to the device base, and wherein the top cover is openable against the chamber for preventing the animal from getting inside the chamber during the rotation.

11. The device of claim 9, further comprising a position sensor unit configured to detect a position of the chamber relative to the device base, wherein a position signal indicating the position is transmitted from the position sensor unit to the microprocessor controller.

12. The device of claim 9, further comprising one or more device weight sensors configured to:
detect any change of weight of the device; and
supply a device weight signal to the microprocessor controller,
wherein the device weight sensor is at least one of a strain gauge, a load cell, a force-sensing resistor, or a combination of two or more thereof.

13. The device of claim 9, further comprising one or more presence sensors configured to:
detect a presence or an absence of the animal; and
supply one or more presence signals to the microprocessor controller,
wherein the presence sensor is at least one of a microwave radar, an ultrasonic sensor, an infrared sensor, a camera, a thermal imaging sensor, a millimeter-wave radar, a laser sensor, or a combination of two or more thereof.

14. The device of claim 9. further comprising one or more waste level gauges configured to:
detect a level of waste accumulated in the receptacle; and
supply one or more waste level signals to the microprocessor controller,
wherein the waste level gauge is at least one of an infrared sensor, a laser sensor, a camera, or a combination of two or more thereof.

15. The device of claim 1, further comprising a flushing device, configured to flush the receptacle in order to remove the animal waste from the receptacle.

16. A method for handling an animal waste deposited in a device, comprising:
providing a litter collection device having a receptacle and a chamber with a chamber opening, wherein the chamber opening serves as an ingress for the animal to deposit the animal waste on a litter material when the chamber is in a first position;
rotating the chamber from the first position to a second position, wherein a litter material passes through at least one of one or more screen sections in the chamber and enters a trough, and wherein the animal waste is kept out of the trough by a partition and removed to a receptacle through the chamber opening;
rotating the chamber from the second position to a third position for the litter material to exit the trough; and
rotating the chamber back to the first position for leveling the litter material.

17. The method of claim 16,
wherein the chamber is located on a device base,
wherein the partition is located within the chamber, comprising the at least one screen section and at least one non-opening section being connected to an interior wall of the chamber, the screen section having one or more screen openings, and
wherein the trough is formed by the non-opening section and the interior wall of the chamber.

18. The method of claim 16, further comprising:
determining, by a chamber weight sensor and a device weight sensor, a presence of the animal within the chamber.

19. The method of claim 16, further comprising:
determining, by a presence sensor, a presence of the animal within a predetermined range from the chamber.

20. The method of claim 16, further comprising:
detecting, by a waste level gauge, a waste level of the receptacle indicating the receptacle is full or substantially full.
